(19) United States
(12) Patent Application Publication
(10) Pub. No.: US 2020/0153275 A1
(43) Pub. Date: May 14, 2020

(54) COMPRESSED AIR STORAGE POWER GENERATION DEVICE AND COMPRESSED AIR STORAGE POWER GENERATION METHOD

(71) Applicant: KABUSHIKI KAISHA KOBE SEIKO SHO (KOBE STEEL, LTD.), Hyogo (JP)

(72) Inventors: Masaki MATSUKUMA, Takasago-shi, Hyogo (JP); Hiroki SARUTA, Takasago-shi, Hyogo (JP); Yuji MATSUO, Takasago-shi, Hyogo (JP); Kanami SAKAMOTO, Takasago-shi, Hyogo (JP)

(73) Assignee: KABUSHIKI KAISHA KOBE SEIKO SHO (KOBE STEEL, LTD.), Hyogo (JP)

(21) Appl. No.: 16/603,254

(22) PCT Filed: Apr. 6, 2018
(86) PCT No.: PCT/JP2018/014779

§ 371 Date: Oct. 7, 2019

(30) Foreign Application Priority Data
Apr. 19, 2017 (JP) 2017-083148

(51) Int. Cl. H02J 15/00; F03D 9/28; F03D 9/17

(52) U.S. Cl. CPC H02J 15/006; F03D 9/17; F03D 9/28

(57) ABSTRACT

A compressed air storage power generation device 1 is provided with: a motor 11 which is driven using input electric power; a compressor 10 which is mechanically connected with the motor and compresses air; a plurality of accumulator tank groups 20A, 20B, 20C, 20D which are in fluid connection with the compressor and in which compressed air obtained by the compressor is stored; a plurality of pressure sensors 21A, 21B, 21C, 21D which are provided in the accumulator tank groups and which measure pressures of the accumulator tank groups; an expander 30 which is in fluid connection with the accumulator tank groups and driven by means of compressed air supplied from the accumulator tank groups; a generator 31 which is mechanically connected with the expander; and a control unit 40 which, on the basis of the pressures of the respective accumulator tank groups measured by means of the pressure sensors, determines the order of the accumulator tank groups in which to store compressed air for charging, and determines the order of the accumulator tank groups in which to supply compressed air to the expander for discharging.

### TECHNICAL FIELD

The present invention relates to a compressed air storage power generation device and a compressed air storage power generation method.

### BACKGROUND ART

A compressed air storage power generation device of Patent Document 1 has at least two tanks differing in capacity. By using the tanks differing in capacity respectively with respect to each of long-period fluctuating power and short-period fluctuating power, each of long-period fluctuating power and short-period fluctuating power is leveled.

### CITATION LIST

### Patent Document

Patent Document 1: JP 2016-34211 A

### SUMMARY OF THE INVENTION

### Problem to be Solved by the Invention

Charge and discharge efficiency of the compressed air storage power generation device is changed depending on the storage amount of compressed air in a pressure accumulation tank used for charge or discharge. However, in Patent Document 1, when selecting the pressure accumulation tank used for charge or discharge, the storage amount of compressed air in the pressure accumulation tank is not considered.

The object of the present invention is to provide a compressed air storage power generation device capable of improving charge and discharge efficiency.

### Means for Solving the Problem

One aspect of the present invention is to provide a compressed air storage power generation device including: a motor which is driven by input power; a compressor which is mechanically connected to the motor and compresses air; a plurality of pressure accumulation tanks which are fluidly connected to the compressor and in which compressed air compressed by the compressor is stored; a plurality of pressure sensors which are provided in the pressure accumulation tanks and measure pressures of the pressure accumulation tanks; an expander which is fluidly connected to the pressure accumulation tanks and driven by compressed air supplied from the pressure accumulation tanks; a generator which is mechanically connected to the expander; and a control unit which, based on the pressures of the respective pressure accumulation tanks measured by the pressure sensors, determines the order of the pressure accumulation tanks in which the compressed air is stored if charge is performed, and determines the order of the pressure accumulation tanks which supply the compressed air to the expander if discharge is performed.

Since each of the plurality of pressure accumulation tanks is fluidly connected to the compressor and the expander, it is possible to determine whether each pressure accumulation tank is used for charge or discharge. Moreover, each pressure accumulation tank is provided with a pressure sensor, and therefore it is possible to know the storage amount of compressed air of each pressure accumulation tank. Therefore, the pressure accumulation tank used for charge or discharge is determined based on the pressure of each pressure accumulation tank, thereby capable of improving charge and discharge efficiency irrespective of charge and discharge efficiency of the whole compressed air storage power generation device.

Moreover, since each of the plurality of pressure accumulation tanks is fluidly connected to the compressor and the expander, it is possible to reduce the storage capacity of compressed air per one pressure accumulation tank compared to the case where one pressure accumulation tank having the storage capacity of compressed air similar to the whole compressed air storage power generation device is used. Therefore, there is no need to manufacture a large-capacity pressure accumulation tank and transportation is facilitated, so it is possible to reduce cost of the compressed air storage power generation device. Further, without stopping the whole compressed air storage power generation device, it is possible to repair or replace the individual pressure accumulation tank.

The control unit may store the compressed air in order from the pressure accumulation tank having highest pressure among the pressure accumulation tanks having pressure lower than a predetermined reference pressure.

Among the plurality of pressure accumulation tanks, the compressed air is stored in order from the one in which the amount of compressed air required for bringing the pressure to the reference pressure is smallest, thereby completing storage of compressed air in a short time. Therefore, it is possible to obtain more pressure accumulation tanks having the reference pressure in a short time. Here, the predetermined reference pressure means a pressure shown by the pressure accumulation tank in a state that the storage amount of compressed air thereof is suitable and charge is efficiently possible.

The control unit may supply the compressed air to the expander in order from the pressure accumulation tank having highest pressure among the plurality of pressure accumulation tanks.

The respective pressure accumulation tanks may be fluidly connected to the compressor by a storage flow path including a storage side valve, and may be fluidly connected to the expander by a release flow path including a release side valve, and the control unit may open and close the storage side valve based on the order of storing the compressed air if charge is performed, and may open and close the release side valve based on the order of supplying the compressed air to the expander if discharge is performed.

According to another aspect of the present invention, provided is a compressed air storage power generation method of a compressed air storage power generation device comprising: a motor which is driven by input power; a compressor which is mechanically connected to the motor and compresses air; a plurality of pressure accumulation tanks which are fluidly connected to the compressor and in which compressed air compressed by the compressor is stored; a plurality of pressure sensors which are provided in the pressure accumulation tanks and measure pressures of the pressure accumulation tanks; an expander which is fluidly connected to the pressure accumulation tanks and driven by compressed air supplied from the pressure accumulation tanks; and a generator which is mechanically connected to the expander, in which, based on the pressures of the respective pressure accumulation tanks measured by the pressure sensors, control is performed so as to determine the order of the pressure accumulation tanks in which the compressed air is stored if charge is performed and determine the order of the pressure accumulation tanks which supply the compressed air to the expander if discharge is performed.

### Effects of the Invention

In the compressed air storage power generation device of the present invention, it is possible to improve charge and discharge efficiency.

### BRIEF DESCRIPTION OF DRAWINGS

FIG. 1 is a schematic system diagram of a compressed air storage power generation device according to the present invention.

FIG. 2 is a schematic configuration diagram of a pressure accumulation tank group in FIG. 1.

FIG. 3 is a flow chart of a charging method of a compressed air storage power generation method.

FIG. 4 is a flow chart of a power generation method of the compressed air storage power generation method.

### DESCRIPTION OF EMBODIMENTS

Hereinafter, referring to the accompanying drawings, a compressed air storage power generation device according to an embodiment of the present invention will be described.

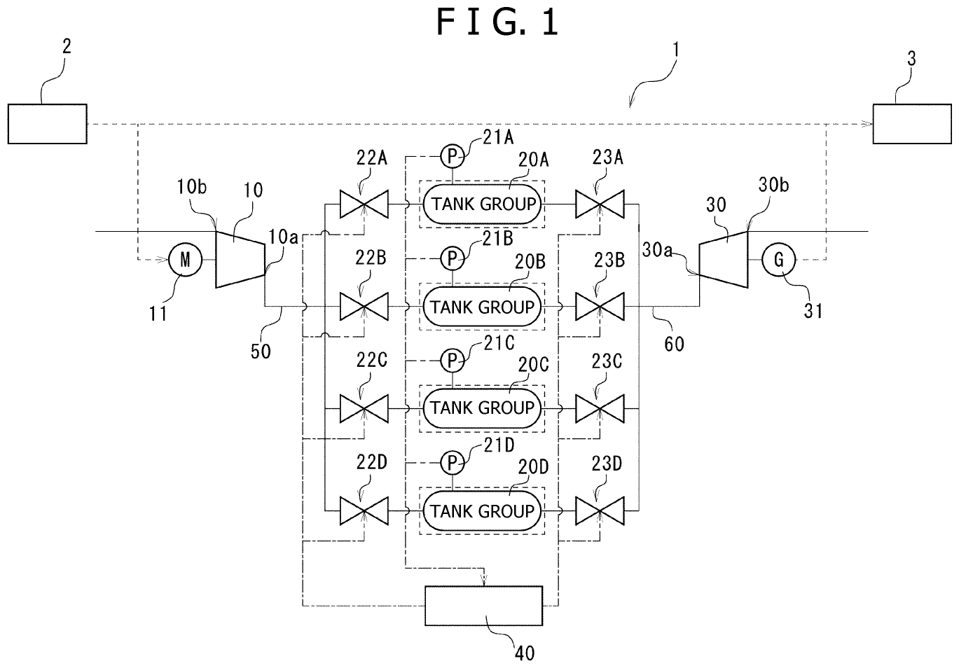

Referring to FIG. 1, a compressed air storage power generation device 1 is electrically connected to an external power generation device 2 and a power system 3 (see broken lines). The external power generation device 2 is a power generation device utilizing natural energy, such as a wind power generation device or a photovoltaic power generation device.

The compressed air storage power generation device 1 of the present embodiment includes a compressor 10, four pressure accumulation tank groups (pressure accumulation tanks) 20A, 20B, 20C, 20D, an expander 30, and a control unit 40. The compressor 10 and the pressure accumulation tank groups 20A, 20B, 20C, 20D are fluidly connected respectively by a storage flow path 50. The expander 30 and the pressure accumulation tank groups 20A, 20B, 20C, 20D are fluidly connected respectively by a release flow path 60.

The compressor 10 is mechanically connected to a motor 11 and driven by the motor 11. A discharge port 10a of the compressor 10 is fluidly connected by the storage flow path 50 respectively to the pressure accumulation tank groups 20A, 20B, 20C, 20D. The compressor 10 sucks air from a suction port 10b when driven by the motor 11, and compresses and discharges it to the storage flow path 50 from the discharge port 10a.

The motor 11 is electrically connected to the external power generation device 2 and driven by power (input power) supplied from the external power generation device 2.

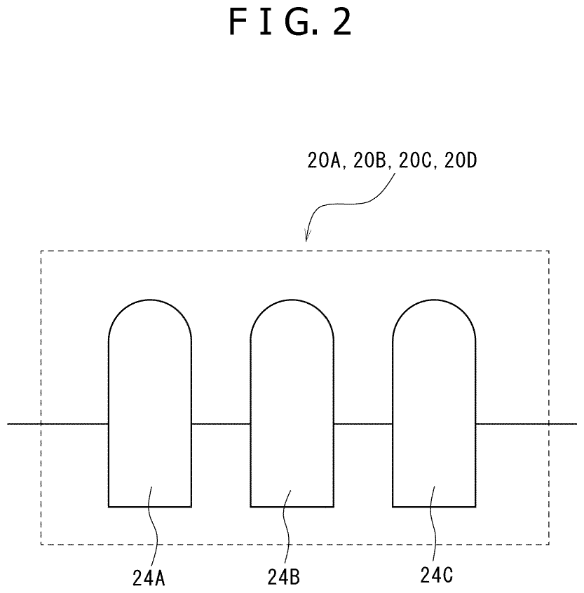

The pressure accumulation tank groups 20A, 20B, 20C, 20D are fluidly connected by the release flow path 60 to the expander 30. Referring to FIG. 2, the pressure accumulation tank groups 20A, 20B, 20C, 20D include three pressure accumulation tanks 24A, 24B, 24C. The pressure accumulation tanks 24A, 24B, 24C store compressed air discharged from the compressor 10. Moreover, the pressure accumulation tank groups 20A, 20B, 20C, 20D include pressure sensors 21A, 21B, 21C, 21D respectively. The pressure sensors 21A, 21B, 21C, 21D measure pressures of the pressure accumulation tank groups 20A, 20B, 20C, 20D respectively.

The expander 30 is mechanically connected to a power generator 31. The expander 30 to which compressed air is supplied from an air supply port 30a of the expander 30 is operated by the supplied compressed air, and drives the power generator 31. That is, the expander 30 expands compressed air stored in the pressure accumulation tank groups 20A, 20B, 20C, 20D and utilizes it for power generation.

The power generator 31 is electrically connected to the power system 3, and power (generated power) generated by the power generator 31 is supplied to the power system 3.

In the storage flow path 50, storage side valves 22A, 22B, 22C, 22D are provided. The storage side valves 22A, 22B, 22C, 22D are opened and closed, thereby permitting or preventing storage of compressed air into the pressure accumulation tank groups 20A, 20B, 20C, 20D.

In the release flow path 60, release side valves 23A, 23B, 23C, 23D are provided. The release side valves 23A, 23B, 23C, 23D are opened and closed, thereby permitting or preventing supply of compressed air from the pressure accumulation tank groups 20A, 20B, 20C, 20D to the expander 30.

The control unit 40 is electrically connected to the pressure sensors 21A, 21B, 21C, 21D, the storage side valves 22A, 22B, 22C, 22D, and the release side valves 23A, 23B, 23C, 23D (see dot and dash lines). The control unit 40 determines, based on the pressures of the pressure accumulation tank groups 20A, 20B, 20C, 20D measured by the pressure sensors 21A, 21B, 21C, 21D, the order of the pressure accumulation tank groups 20A, 20B, 20C, 20D in which the compressed air is stored if charge is performed. Moreover, the control unit 40 determines, based on the pressures of the pressure accumulation tank groups 20A, 20B, 20C, 20D measured by the pressure sensors 21A, 21B, 21C, 21D, the order of the pressure accumulation tank groups 20A, 20B, 20C, 20D which supply the compressed air to the expander 30 if discharge is performed. The control unit 40 controls opening and closing of the storage side valves 22A, 22B, 22C, 22D and the release side valves 23A, 23B, 23C, 23D, and switches the pressure accumulation tank groups 20A, 20B, 20C, 20D which store or release compressed air.

Since the pressure accumulation tank groups 20A, 20B, 20C, 20D are fluidly connected to the compressor 10 and the expander 30, it is possible to determine whether each of the pressure accumulation tank groups 20A, 20B, 20C, 20D is used for charge or discharge. Moreover, the respective pressure accumulation tank groups 20A, 20B, 20C, 20D are provided with the pressure sensors 21A, 21B, 21C, 21D, and therefore it is possible to know the storage amount of compressed air of the respective pressure accumulation tank groups 20A, 20B, 20C, 20D. Therefore, the pressure accumulation tank group used for charge or discharge is determined based on the pressure of each pressure accumulation tank group, thereby capable of improving charge and discharge efficiency irrespective of charge and discharge efficiency of the whole compressed air storage power generation device 1.

Moreover, since the pressure accumulation tank groups 20A, 20B, 20C, 20D are fluidly connected to the compressor 10 and the expander 30, it is possible to reduce the storage capacity of compressed air per one pressure accumulation tank compared to the case where one pressure accumulation tank having the storage capacity of compressed air similar to the storage capacity of compressed air of the whole compressed air storage power generation device 1 is used. Therefore, there is no need to manufacture a large-capacity pressure accumulation tank and transportation is facilitated, so it is possible to reduce cost of the compressed air storage power generation device. Further, without stopping the whole compressed air storage power generation device, it is possible to repair or replace the individual pressure accumulation tank.

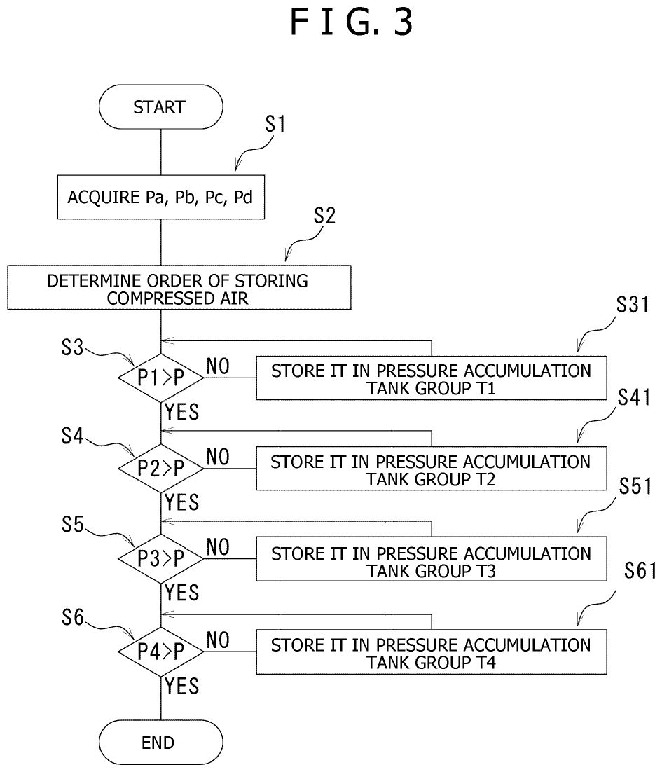

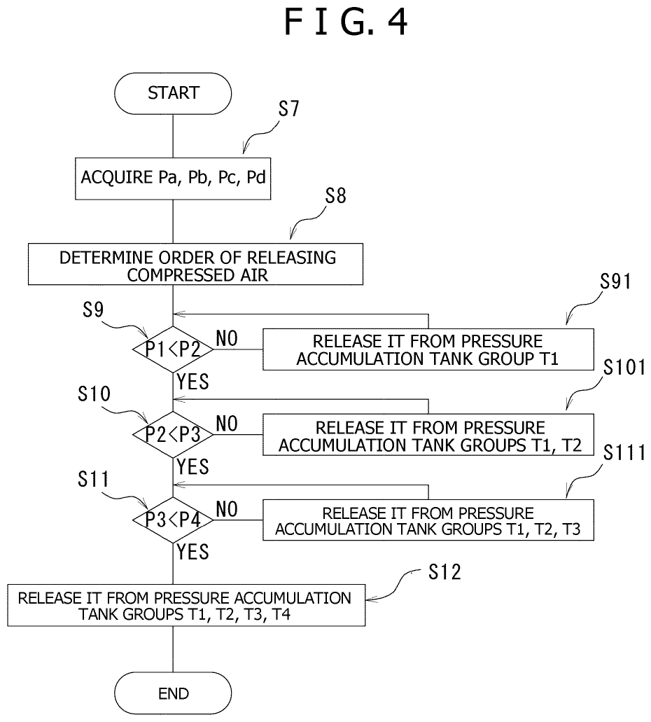

Hereinafter, referring to FIGS. 3 and 4, a compressed air storage power generation method of the compressed air storage power generation device 1 according to the present embodiment will be described.

### (Power Generation Method)

Referring to FIG. 3, a charging method of the compressed air storage power generation device 1 of the present embodiment will be described. The compressed air storage power generation device 1 begins to charge when input power is supplied from the external power generation device 2.

Firstly, the control unit 40 acquires pressures Pa, Pb, Pc, Pd of the pressure accumulation tank groups 20A, 20B, 20C, 20D from the pressure sensors 21A, 21B, 21C, 21D (Step S1).

Secondly, based on the pressures Pa, Pb, Pc, Pd of the pressure accumulation tank groups 20A, 20B, 20C, 20D acquired in Step S1, the order of the pressure accumulation tank groups in which compressed air is stored is determined (Step S2). Specifically, by comparing the pressures Pa, Pb, Pc, Pd of the pressure accumulation tank groups 20A, 20B, 20C, 20D, the magnitude relationship of the pressures Pa, Pb, Pc, Pd is judged. The pressures Pa, Pb, Pc, Pd are assumed to be pressures P1, P2, P3, P4 in order from the highest one, and the pressure accumulation tank groups having the pressures P1, P2, P3, P4 are assumed to be pressure accumulation tank groups T1, T2, T3, T4 respectively. Storage of compressed air is performed in order of the pressure accumulation tank groups T1, T2, T3, T4. That is, compressed air is stored in order from the pressure accumulation tank group having the highest pressure.

The magnitude relationship of the pressure P1 of the pressure accumulation tank group T1 and a predetermined reference pressure P is judged (Step S3), and if the pressure P1 of the pressure accumulation tank group T1 is equal to or less than the predetermined reference pressure P, compressed air is stored in the pressure accumulation tank group T1 (Step S31). Here, the predetermined reference pressure P means a pressure shown by the pressure accumulation tank group in a state that the storage amount of compressed air thereof is suitable and charge is efficiently possible.

If the pressure P1 of the pressure accumulation tank group T1 reaches the reference pressure P by storage of compressed air, or if the pressure P1 of the pressure accumulation tank group T1 is larger than the reference pressure P from the beginning, Step S4 is started.

The magnitude relationship of the pressure P2 of the pressure accumulation tank group T2 and the predetermined reference pressure P is judged (Step S4), and if the pressure P2 of the pressure accumulation tank group T2 is equal to or less than the predetermined reference pressure P, compressed air is stored in the pressure accumulation tank group T2 (Step S41).

If the pressure P2 of the pressure accumulation tank group T2 reaches the reference pressure P by storage of compressed air, or if the pressure P2 of the pressure accumulation tank group T2 is larger than the reference pressure P from the beginning, Step S5 is started.

The magnitude relationship of the pressure P3 of the pressure accumulation tank group T3 and the predetermined reference pressure P is judged (Step S5), and if the pressure P3 of the pressure accumulation tank group T3 is equal to or less than the predetermined reference pressure P, compressed air is stored in the pressure accumulation tank group T3 (Step S51).

If the pressure P3 of the pressure accumulation tank group T3 reaches the reference pressure P by storage of compressed air, or if the pressure P3 of the pressure accumulation tank group T3 is larger than the reference pressure P from the beginning, Step S6 is started.

The magnitude relationship of the pressure P4 of the pressure accumulation tank group T4 and the predetermined reference pressure P is judged (Step S6), and if the pressure P4 of the pressure accumulation tank group T4 is equal to or less than the predetermined reference pressure P, compressed air is stored in the pressure accumulation tank group T4 (Step S61).

If the pressure P4 of the pressure accumulation tank group T4 reaches the reference pressure P by storage of compressed air, or if the pressure P4 of the pressure accumulation tank group T4 is larger than the reference pressure P from the beginning, charge is finished. That is, when all of the pressure accumulation tank groups T1, T2, T3, T4 have a higher pressure than the reference pressure P, charge is finished.

Moreover, storage of air into the pressure accumulation tank groups T1, T2, T3, T4 is also finished if supply of input power from the external power generation device 2 is stopped.

Even if all of the pressure accumulation tank groups T1, T2, T3, T4 have a higher pressure than the reference pressure P, without finishing storage of compressed air, storage of compressed air may be continued simultaneously or individually with respect to the plurality of pressure accumulation tank groups.

According to the charging method, among the plurality of pressure accumulation tank groups T1, T2, T3, T4, compressed air is stored in order from the one in which the amount of compressed air required for bringing the pressure to the reference pressure P is smallest, thereby completing storage of compressed air in a short time. Therefore, it is possible to obtain more pressure accumulation tank groups having the reference pressure P in a short time.

### (Power Generation Method)

Referring to FIG. 4, a power generation method of the compressed air storage power generation device 1 of the present embodiment will be described. The compressed air storage power generation device 1 starts power generation when received power supply instructions from the power system 3.

Firstly, the control unit 40 acquires the pressures Pa, Pb, Pc, Pd of the pressure accumulation tank groups 20A, 20B, 20C, 20D from the pressure sensors 21A, 21B, 21C, 21D (Step S7).

Secondly, based on the pressures Pa, Pb, Pc, Pd of the pressure accumulation tank groups 20A, 20B, 20C, 20D acquired in Step S7, the order of the pressure accumulation tank groups which supply compressed air to the expander 30 is determined (Step S8). Specifically, by comparing the pressures Pa, Pb, Pc, Pd of the pressure accumulation tank groups 20A, 20B, 20C, 20D, the magnitude relationship of the pressures Pa, Pb, Pc, Pd is judged. The pressures Pa, Pb, Pc, Pd are assumed to be the pressures P1, P2, P3, P4 in order from the highest one, and the pressure accumulation tank groups having the pressures P1, P2, P3, P4 are assumed to be the pressure accumulation tank groups T1, T2, T3, T4 respectively. Supply of compressed air to the expander 30 is performed in order of the pressure accumulation tank groups T1, T2, T3, T4. That is, compressed air is supplied to the expander 30 in order from the pressure accumulation tank group having the highest pressure.

The magnitude relationship of the pressure P1 of the pressure accumulation tank group T1 and the pressure P2 of the pressure accumulation tank group T2 is judged (Step S9), and if the pressure P1 of the pressure accumulation tank group T1 is equal to or more than the pressure P2 of the pressure accumulation tank group T2, compressed air used for power generation is released from the pressure accumulation tank group T1 (Step S91).

If the pressure P1 of the pressure accumulation tank group T1 reaches the pressure P2 of the pressure accumulation tank group T2 by release of compressed air, Step S10 is started.

The magnitude relationship of the pressure P2 of the pressure accumulation tank group T2 and the pressure P3 of the pressure accumulation tank group T3 is judged (Step S10), and if the pressure P2 of the pressure accumulation tank group T2 is equal to or more than the pressure P3 of the pressure accumulation tank group T3, compressed air used for power generation is released from the pressure accumulation tank group T1 and the pressure accumulation tank group T2 (Step S101).

If the pressure P1 of the pressure accumulation tank group T1 and the pressure P2 of the pressure accumulation tank group T2 reach the pressure P3 of the pressure accumulation tank group T3 by release of compressed air, Step S11 is started.

The magnitude relationship of the pressure P3 of the pressure accumulation tank group T3 and the pressure P4 of the pressure accumulation tank group T4 is judged (Step S11), and if the pressure P3 of the pressure accumulation tank group T3 is equal to or more than the pressure P4 of the pressure accumulation tank group T4, compressed air used for power generation is released from the pressure accumulation tank group T1, the pressure accumulation tank group T2, and the pressure accumulation tank group T3 (Step S111).

If the pressure P1 of the pressure accumulation tank group T1, the pressure P2 of the pressure accumulation tank group T2, and the pressure P3 of the pressure accumulation tank group T3 reach the pressure P4 of the pressure accumulation tank group T4 by release of compressed air, Step S12 is started.

In step S12, compressed air used for power generation is released from the pressure accumulation tank group T1, the pressure accumulation tank group T2, the pressure accumulation tank group T3, and the pressure accumulation tank group T4.

In the power generation method of the present embodiment, power generation is finished if the power supply instructions from the power system 3 are stopped.

In the power generation method of the present embodiment, when the pressure of the pressure accumulation tank group which releases compressed air becomes less than the pressures of the other pressure accumulation tank groups, the pressure accumulation tank group which releases compressed air is switched, but the pressure accumulation tank group may be switched when the pressure of the pressure accumulation tank group which releases compressed air becomes less than a predetermined threshold value.

Hereinbefore, although the preferred embodiment of the present invention has been described, the present invention is not limited to the specific embodiment, and various changes can be made within the gist of the present invention described in the claims.

For example, the number of the pressure accumulation tank groups may be two, or may be four or more.

Moreover, the number of the pressure accumulation tanks included in the pressure accumulation tank group is not limited to three, but may be different between the pressure accumulation tank groups.

The compressed air storage power generation device may include a plurality of compressors, and may include a plurality of expanders.

The plurality of pressure accumulation tanks may have different air storage capacities to each other.

A valve may be provided between one pressure accumulation tank and another pressure accumulation tank, and the individual pressure accumulation tank may be provided with a pressure sensor.

In the compressed air storage power generation method, charge and discharge may be simultaneously performed.

### EXPLANATION OF REFERENCE NUMERALS

1: Compressed air storage power generation device
2: External power generation device
3: Power system
10: Compressor
10a: Discharge port
10b: Suction port
11: Motor
20A, 20B, 20C, 20D: Pressure accumulation tank group (Pressure
accumulation tank)
21A, 21B, 21C, 21D: Pressure sensor
22A, 22B, 22C, 22D: Storage side valve
23A, 23B, 23C, 23D: Discharge side valve
24A, 24B, 24C: Pressure accumulation tank
30: Expander
31: Generator
40: Control unit
50: Storage flow path
60: Release flow path
Pa, Pb, Pc, Pd: Pressure
P: Reference pressure
P1, P2, P3, P4: Pressure
T1, T2, T3, T4: Pressure accumulation tank group

1. A compressed air storage power generation device comprising:
a motor which is driven by input power;
a compressor which is mechanically connected to the motor and compresses air;
a plurality of pressure accumulation tanks which are fluidly connected to the compressor and in which compressed air compressed by the compressor is stored;
a plurality of pressure sensors which are provided in the pressure accumulation tanks and measure pressures of the pressure accumulation tanks;
an expander which is fluidly connected to the pressure accumulation tanks and driven by compressed air supplied from the pressure accumulation tanks;
a generator which is mechanically connected to the expander; and
a control unit which, based on the pressures of the respective pressure accumulation tanks measured by the pressure sensors, determines the order of the pressure accumulation tanks in which the compressed air is stored if charge is performed, and determines the order of the pressure accumulation tanks which supply the compressed air to the expander if discharge is performed.

2. The compressed air storage power generation device according to claim 1, wherein the control unit stores the compressed air in order from the pressure accumulation tank having highest pressure among the pressure accumulation tanks having pressure lower than a predetermined reference pressure.

3. The compressed air storage power generation device according to claim 1, wherein the control unit supplies the compressed air to the expander in order from the pressure accumulation tank having highest pressure among the plurality of pressure accumulation tanks.

4. The compressed air storage power generation device according to claim 1, wherein
the respective pressure accumulation tanks are fluidly connected to the compressor by a storage flow path including a storage side valve, and are fluidly connected to the expander by a release flow path including a release side valve, and
the control unit opens and closes the storage side valve based on the order of storing the compressed air if charge is performed, and opens and closes the release side valve based on the order of supplying the compressed air to the expander if discharge is performed.

5. A compressed air storage power generation method of a compressed air storage power generation device comprising:
a motor which is driven by input power;
a compressor which is mechanically connected to the motor and compresses air;
a plurality of pressure accumulation tanks which are fluidly connected to the compressor and in which compressed air compressed by the compressor is stored;
a plurality of pressure sensors which are provided in the pressure accumulation tanks and measure pressures of the pressure accumulation tanks;
an expander which is fluidly connected to the pressure accumulation tanks and driven by compressed air supplied from the pressure accumulation tanks; and
a generator which is mechanically connected to the expander,
wherein, based on the pressures of the respective pressure accumulation tanks measured by the pressure sensors, control is performed so as to determine the order of the pressure accumulation tanks in which the compressed air is stored if charge is performed and determine the order of the pressure accumulation tanks which supply the compressed air to the expander if discharge is performed.

6. The compressed air storage power generation device according to claim 2, wherein
the respective pressure accumulation tanks are fluidly connected to the compressor by a storage flow path including a storage side valve, and are fluidly connected to the expander by a release flow path including a release side valve, and
the control unit opens and closes the storage side valve based on the order of storing the compressed air if charge is performed, and opens and closes the release side valve based on the order of supplying the compressed air to the expander if discharge is performed.

7. The compressed air storage power generation device according to claim 3, wherein
the respective pressure accumulation tanks are fluidly connected to the compressor by a storage flow path including a storage side valve, and are fluidly connected to the expander by a release flow path including a release side valve, and
the control unit opens and closes the storage side valve based on the order of storing the compressed air if charge is performed, and opens and closes the release side valve based on the order of supplying the compressed air to the expander if discharge is performed.
